(19) United States
(12) Patent Application Publication
(10) Pub. No.: US 2026/0291609 A1
(43) Pub. Date: Sep. 24, 2026

(54) BIDIRECTIONAL COMMUNICATIONS IN PASSIVE OPTICAL NETWORKS

(71) Applicant: Nokia Solutions and Networks Oy, Espoo (FI)

(72) Inventors: Kovendhan Vijayan, Murray Hill, NJ (US); Robert Borkowski, Murray Hill, NJ (US)

(21) Appl. No.: 19/086,840

(22) Filed: Mar. 21, 2025

(51) Int. Cl. H04B 10/27

(52) U.S. Cl. CPC H04B 10/27

(57) ABSTRACT

Various example embodiments of a bidirectional optical communication capability may be configured to support bidirectional communications in a passive optical network (PON) between a first set of communication devices and a second set of communication devices connected via an optical distribution network (ODN). The ODN includes a passive optical splitter and an optical core multiplex including a set of optical fiber cores. The ODN is configured to support communications of an optical system, such as a passive optical network (PON) system supporting communications between optical line terminals (OLTs) and optical network units (ONUs), a point-to-point optical communication system, or the like. The optical core multiplex is configured to support optical communications of the optical system in a manner for reducing or eliminating detrimental interaction between the downstream optical signals and the upstream optical signals (e.g., distributed Rayleigh backscattering (DRBS), self-induced and coexistence-induced Raman depletion, or the like).

### TECHNICAL FIELD

Various example embodiments relate generally to communication networks and, more particularly but not exclusively, to supporting bidirectional optical communications in passive optical networks.

### BACKGROUND

Various communications technologies may be used to support communications in various types of communications systems.

### SUMMARY

In at least some example embodiments, a system includes a passive optical splitter and an optical core multiplex for use in an optical distribution network of a passive optical network, wherein the optical core multiplex includes a set of optical fiber cores and is configured to support communications of an optical system including an optical channel pair including a downstream channel and an upstream channel, wherein a first channel of the optical channel pair is absent in at least one of the optical fiber cores of the optical core multiplex and a second channel of the optical channel pair is propagating in at least one of the optical fiber cores in which the first channel of the optical channel pair is absent and is used for active communications of the optical system in the at least one of the optical fiber cores in which the first channel of the optical channel pair is absent.

In at least some example embodiments, the optical distribution network includes a feeder section between a first set of communication devices and the passive optical splitter and includes a drop section between the passive optical splitter and a second set of communication devices, wherein the optical core multiplex is disposed within the feeder section of the optical distribution network. In at least some example embodiments, the optical core multiplex includes a first optical feeder core and a second optical feeder core. In at least some example embodiments, the optical core multiplex is configured to support a condition in which the downstream channel is absent in at least one of the optical feeder cores of the optical core multiplex in which the upstream channel is present, and one of the optical feeder cores of the optical core multiplex where the condition is fulfilled is used for active upstream reception. In at least some example embodiments, a transmit power of the first set of communication devices is greater than a transmit power of the second set of communication devices.

In at least some example embodiments, the optical distribution network includes a feeder section between a first set of communication devices and the passive optical splitter and includes a drop section between the passive optical splitter and a second set of communication devices, wherein the optical core multiplex is disposed within the drop section of the optical distribution network for a given communication device in the second set of communication devices. In at least some example embodiments, the optical core multiplex includes a first optical drop core and a second optical drop core. In at least some example embodiments, the optical core multiplex is configured to support a condition in which the upstream channel is absent in at least one of the optical drop cores of the optical core multiplex in which the downstream channel is present, and one of the optical drop cores of the optical core multiplex where the condition is fulfilled is used for active downstream reception. In at least some example embodiments, the first optical drop core and the second optical drop core are both directly connected to the passive optical splitter and directly connected to the given communication device. In at least some example embodiments, the first optical drop core and the second optical drop core are both directly connected to the passive optical splitter, wherein the first optical drop core is connected to a second passive optical splitter disposed between the passive optical splitter and the given communication device, wherein the second optical drop core is directly connected to the given communication device. In at least some example embodiments, the first optical drop core is directly connected to the passive optical splitter and the given communication device, wherein the second optical drop core is directly connected to a second passive optical splitter and the given communication device. In at least some example embodiments, the first optical drop core is directly connected to the passive optical splitter and the given communication device, wherein the second optical drop core is directly connected to the optical line terminal and the given communication device. In at least some example embodiments, a transmit power of the first set of communication devices is less than a transmit power of the second set of communication devices.

In at least some example embodiments, the downstream channel and the upstream channel use a common wavelength. In at least some example embodiments, the optical distribution network includes a multiplex converter disposed between the optical core multiplex and the passive optical splitter, wherein the multiplex converter is configured to operate on at least one of wavelength bands or direction. In at least some example embodiments, the optical fiber cores of the optical core multiplex are disposed within at least one optical fiber. In at least some example embodiments, the optical system includes a point-to-multipoint system or a point-to-point system. In at least some example embodiments, the optical system includes at least one of a 25GS passive optical network system, a 50G passive optical network system, a VHSP passive optical network system, a GPON passive optical network system, an XGS passive optical network system, or an NG-PON2 passive optical network system.

In at least some example embodiments, a method for use for a passive optical network includes providing a passive optical splitter and an optical core multiplex for use in an optical distribution network of a passive optical network, wherein the optical core multiplex includes a set of optical fiber cores and is configured to support communications of an optical system including an optical channel pair including a downstream channel and an upstream channel, and supporting communications of the optical system such that a first channel of the optical channel pair is absent in at least one of the optical fiber cores of the optical core multiplex and a second channel of the optical channel pair is propagating in at least one of the optical fiber cores in which the first channel of the optical channel pair is absent and is used for active communications of the optical system in the at least one of the optical fiber cores in which the first channel of the optical channel pair is absent.

In at least some example embodiments, an apparatus includes a passive optical splitter and an optical core multiplex for use in an optical distribution network of a passive optical network, wherein the optical core multiplex includes a set of optical fiber cores and is configured to support communications of an optical system including an optical channel pair including a downstream channel and an upstream channel, wherein a first channel of the optical channel pair is absent in at least one of the optical fiber cores of the optical core multiplex and a second channel of the optical channel pair is propagating in at least one of the optical fiber cores in which the first channel of the optical channel pair is absent and is used for active communications of the optical system in the at least one of the optical fiber cores in which the first channel of the optical channel pair is absent.

In at least some example embodiments, an apparatus includes an optical core multiplex for use in an optical distribution network of a passive optical network, wherein the optical core multiplex includes a set of optical fiber cores and is configured to support communications of an optical system including an optical channel pair including a downstream channel and an upstream channel, wherein a first channel of the optical channel pair is absent in at least one of the optical fiber cores of the optical core multiplex and a second channel of the optical channel pair is propagating in at least one of the optical fiber cores in which the first channel of the optical channel pair is absent and is used for active communications of the optical system in the at least one of the optical fiber cores in which the first channel of the optical channel pair is absent.

In at least some example embodiments, an optical core multiplex for use in an optical distribution network of a passive optical network includes a set of optical fiber cores configured to support communications of an optical system including an optical channel pair including a downstream channel and an upstream channel, wherein a first channel of the optical channel pair is absent in at least one of the optical fiber cores of the optical core multiplex and a second channel of the optical channel pair is propagating in at least one of the optical fiber cores in which the first channel of the optical channel pair is absent and is used for active communications of the optical system in the at least one of the optical fiber cores in which the first channel of the optical channel pair is absent.

### BRIEF DESCRIPTION OF THE DRAWINGS

The teachings herein can be readily understood by considering the following detailed description in conjunction with the accompanying drawings, in which:

FIG. 1 depicts an example embodiment of a passive optical network (PON) configured to support bidirectional optical communication based on an optical feeder section including multiple optical feeder cores;

FIG. 2 depicts an example embodiment of a portion of a PON having an optical feeder section including multiple optical feeder cores where the optical feeder cores are disposed in a pair of optical feeder fibers and where network-side ends of the optical fibers are connected to a directional splitter and user-side ends of the optical fibers are connected to a passive splitter;

FIG. 3 depicts an example embodiment of a portion of a PON having an optical feeder section including multiple optical feeder cores where the optical feeder cores are disposed in a pair of optical feeder fibers and where network-side ends of the optical fibers are connected to a first directional splitter and user-side ends of the optical fibers are connected to a second directional splitter;

FIG. 4 depicts an example embodiment of a portion of a PON having an optical feeder section including multiple optical feeder cores where the optical feeder cores are disposed in a single multi-core optical feeder fiber and where network-side ends of the optical feeder cores are connected to a first directional splitter and user-side ends of the optical feeder cores are connected to a second directional splitter;

FIG. 5 depicts an example embodiment of a method for supporting bidirectional optical communications in a PON based on use of a set of optical feeder cores in an ODN of the PON;

FIG. 6 depicts a set of plots of operation of the downstream, the upstream, and a combination of the downstream and the upstream for different launch powers at the central office side and the user side as well as various loss budgets;

FIG. 7 depicts an example embodiment of a portion of a PON including an ODN where the ODN includes a pair of optical drop cores supporting an ONU of the PON, and where a first of the optical drop cores is connected to a passive optical splitter of the ODN and connected to the ONU and where a second optical drop core also is connected to the passive optical splitter of the ODN and connected to the ONU;

FIG. 8 depicts an example embodiment of a portion of a PON including an ODN where the ODN includes a pair of optical drop cores supporting an ONU of the PON, and where a first optical drop core is connected to a passive optical splitter associated with a feeder section of the ODN and connected to a second passive optical splitter disposed between the passive optical splitter and the ONU and where a second optical drop core is connected to the passive optical splitter associated with the feeder section of the ODN and connected to the ONU;

FIG. 9 depicts an example embodiment of a portion of a PON including an ODN where the ODN includes a pair of optical drop cores supporting an ONU of the PON, and where a first of the optical drop cores is connected to a first passive optical splitter of the ODN and connected to the ONU and where a second of the optical drop cores is connected to a second passive optical splitter of the ODN and is connected to the ONU;

FIG. 10 depicts an example embodiment of a portion of a PON including an ODN where the ODN includes a pair of optical drop cores supporting an ONU of the PON, and where a first of the optical drop cores is connected to a first passive optical splitter of the ODN and connected to the ONU and where a second of the optical drop cores is connected to a second passive optical splitter of the ODN and is connected to the ONU;

FIG. 11 depicts an example embodiment of a method for supporting bidirectional optical communications in a PON based on use of a set of optical drop cores in an ODN of the PON;

FIG. 12 depicts an example embodiment of a communication system including a PON ODN configured to support bidirectional optical communications based on a combination of a passive optical splitter and an optical core multiplex including a set of optical fiber cores configured to support optical communications within the PON ODN;

FIG. 13 depicts an example embodiment of a method for supporting bidirectional optical communications in an ODN based on use of an optical core multiplex including a set of optical fiber cores in the ODN; and

FIG. 14 depicts an example embodiment of a computer suitable for use in performing various functions presented herein.

To facilitate understanding, identical reference numerals have been used herein, wherever possible, in order to designate identical elements that are common among the various figures.

### DETAILED DESCRIPTION

Various example embodiments of a bidirectional optical communication capability are presented herein. Various example embodiments of a bidirectional optical communication capability may be configured to support bidirectional communications in a passive optical network (PON) between a first set of communication devices and a second set of communication devices connected via an optical distribution network (ODN) of the PON. The PON ODN includes a passive optical splitter and an optical core multiplex including a set of optical fiber cores. The PON ODN is configured to support communications of an optical system, such as a point-to-multipoint optical communication system (e.g., PON system supporting communications between optical line terminals (OLTs) and optical network units (ONUs)), a point-to-point optical communication system, or the like. The optical core multiplex may be configured to support communications of an optical system including an optical channel pair including a downstream channel and an upstream channel, where a first channel of the optical channel pair is absent in at least one of the optical fiber cores of the optical core multiplex and a second channel of the optical channel pair is propagating in at least one of the optical fiber cores in which the first channel of the optical channel pair is absent and is used for active communications of the optical system in the at least one of the optical fiber cores in which the first channel of the optical channel pair is absent. The optical core multiplex may be an optical core duplex (including two optical fiber cores), an optical core triplex including three optical fiber cores, or may include greater numbers of optical fiber cores. In at least some such embodiments, the set of optical fiber cores of the optical core multiplex may include one or more additional optical fiber cores which may be used for protection of other ones of the optical fiber cores of the optical fiber complex. The optical core multiplex is configured to support optical communications of the optical system in a manner for reducing or eliminating detrimental interaction between the downstream optical signals and the upstream optical signals (e.g., distributed Rayleigh backscattering (DRBS), self-induced and coexistence-induced Raman depletion, or the like).

Various example embodiments of the bidirectional optical communication capability may be configured to support bidirectional communications in a PON, between a set of OLTs and a set of ONUs connected via an ODN, based on configuration of the ODN to include, for at least one PON system supported within the PON and connected to the ODN, an optical core multiplex including a set of optical fiber cores where the optical core multiplex is communicatively connected (e.g., either directly or indirectly via one or more other elements, such as a multiplex converter) to a passive optical splitter of the ODN (e.g., either on the central office/feeder side of the ODN or the user location/drop side of the ODN). The PON may be configured such that, for a PON system connected to the ODN with an optical channel pair including a downstream channel and an upstream channel, a first channel of the optical channel pair is absent in at least one of the optical fiber cores of the optical core multiplex and a second channel of the optical channel pair is propagating in at least one of the optical fiber cores in which the first channel of the optical channel pair is absent and is used for active communications of the optical system in the at least one of the optical fiber cores in which the first channel of the optical channel pair is absent. The optical fiber multiplex, as indicated above and discussed further below, may be (1) on the feeder side of the passive optical splitter of the ODN, implemented as a set of optical feeder cores for serving each of the ONUs or (2) on the drop side of the passive optical splitter of the ODN such that, for each of at least one ONU served by the ODN, the optical core multiplex including the set of optical fiber cores may be implemented as a set of optical drop cores for the at least one ONU, respectively (e.g., each of one or more ONUs served by the ODN may have its own optical fiber complex including a set of optical drop cores for the ONU). In at least some such embodiments, the optical fiber cores of the optical core multiplex may be disposed in different optical fibers or the same optical fiber. In at least some such embodiments, the set of optical fiber cores of the optical core multiplex may include one or more additional optical fiber cores which may be used for protection of other ones of the optical fiber cores of the optical fiber complex.

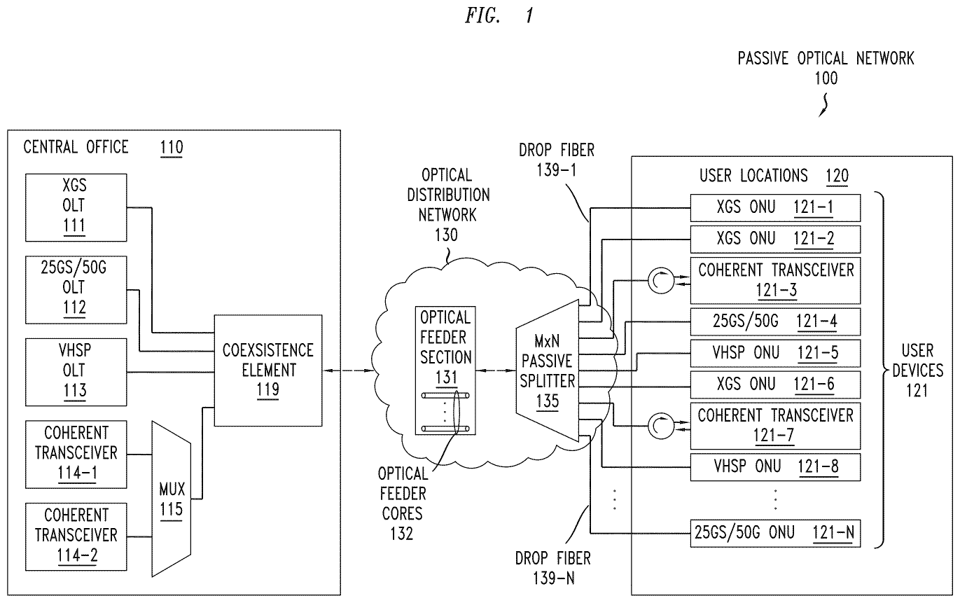

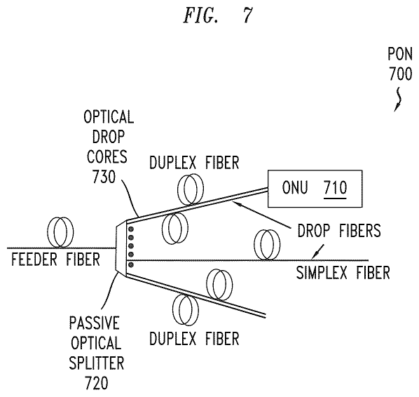

Various example embodiments of the bidirectional optical communication capability, as indicated above, may be configured to support bidirectional communications in a PON based on a set of optical feeder cores disposed in the ODN between the OLTs and an optical splitter of the ODN. The set of optical feeder cores may include at least a first optical feeder core and a second optical feeder core. The set of optical feeder cores is configured to support communications of an optical system, where the optical system includes an optical channel pair including a downstream channel and an upstream channel, including supporting communications to satisfy a condition in which the downstream channel is absent in at least one of the optical feeder cores in which the upstream channel is present and supporting communications such that one of the optical feeder cores where the condition is fulfilled is used for active upstream reception. The first and second optical feeder cores may be disposed in different optical fibers or the same optical fiber. The downstream optical signals and the upstream optical signals may have a common wavelength, and downstream optical signals may have a first transmit power and the upstream optical signals may have a second transmit power lower than the first transmit power. The set of optical feeder cores may include one or more additional optical feeder cores which may be used for protection of the first and second optical feeder cores. The set of optical feeder cores may be deployed within the ODN in various ways (e.g., using a single directional splitter deployed between network-side ends of the optical feeder cores and the OLT(s) with the user-side ends of the optical feeder cores being directly connected to the optical splitter, using a pair of directional splitters including a first directional splitter deployed between network-side ends of the optical feeder cores and the OLT(s) and a second directional splitter deployed between the user-side ends of the optical feeder cores and the optical splitter, without using any directional splitters between the OLT(s) and the optical splitter, or the like). It will be appreciated that at least some such example embodiments may be further understood by way of reference to FIGS. 1-6 and FIGS. 12-13. Various example embodiments of the bidirectional optical communication capability, as indicated above, may be configured to support bidirectional communications in a PON based on a set of optical drop cores disposed in the ODN between an optical splitter of the ODN and an ONU. The set of optical drop cores may include at least a first optical drop core and a second optical drop core. The set of optical drop cores is configured to support communications of an optical system, where the optical system includes an optical channel pair including a downstream channel and an upstream channel, including supporting communications to satisfy a condition in which the upstream channel is absent in at least one of the optical drop cores in which the downstream channel is present and supporting communications such that one of the optical drop cores where the condition is fulfilled is used for active downstream reception. The first and second optical drop cores may be disposed in different optical fibers or the same optical fiber. The downstream optical signals and the upstream optical signals may have a common wavelength, and downstream optical signals may have a first transmit power and the upstream optical signals may have a second transmit power greater than the first transmit power. The set of optical drop cores may include one or more additional optical drop cores which may be used for protection of the first and second optical drop cores. The set of optical drop cores may be deployed within the ODN in various ways (e.g., with or without using a directional splitter between optical splitter and the ONU, with or without using one or more additional splitters between the optical splitter and the ONU, or the like, as well as various combinations thereof). It will be appreciated that at least some such example embodiments may be further understood by way of reference to FIGS. 7-11 and FIGS. 12-13.

It will be appreciated that such example embodiments of the bidirectional optical communication capability, based on use of an optical core multiplex including a set of optical fiber cores where the optical core multiplex is communicatively connected (e.g., either directly or indirectly via one or more other elements, such as a multiplex converter) to a passive optical splitter of the ODN (e.g., either on the central office/feeder side of the ODN or the user location/drop side of the ODN), may enable improved support for bidirectional communications within the PON, including enabling support for bidirectional communication on the same wavelength while operating the downstream and upstream communications on the same wavelength, enabling achievement of high loss budget by overcoming distributed Rayleigh backscattering, and enabling mitigation of Raman depletions (including self-induced and coexistence-induced Raman depletions) and potentially other inter-channel effects between transmission directions and/or wavelength bands. It will be appreciated that these example embodiments of the bidirectional optical communication capability, as well as various other example embodiments of the bidirectional optical communication capability, may be further understood by first considering various aspects of existing PONs that utilize a single feeder fiber between the OLT and the passive splitter(s) in the ODN and between the passive splitter in the ODN and each of the ONUs served by the ODN.

Passive optical networks (PONs) are primarily used to provide Internet access to residential users. PON users are connected to the central office using a point-to-multipoint (P2MP) optical distribution network (ODN) composed of passive splitters/combiners. More than one PON system can exist in the same ODN, an arrangement known as coexistence. For example, PON systems such as XGS PON, 25GS/50G PON, and VHSP could potentially simultaneously operate over a single ODN, thanks to their thoughtfully designed wavelength plans. The ODN also may be used as a logical point-to-point (P2P) link to serve high bandwidth to dedicated users, an arrangement typically referred to as a P2P PON overlay. The ODN typically is composed of a single feeder fiber between the central office and the passive splitter, and the users are connected to the splitter via drop fibers. The total fiber length between the central office and any user, including both the feeder and drop fibers, is usually 0-20 km, but could be up to 40 km or even more in some cases. While this arrangement has various advantages, it also may suffer from certain drawbacks under certain conditions or in certain scenarios. For example, this arrangement may result in challenges due to both distributed Rayleigh backscattering (DRBS) and Raman depletion, which may cause various issues in PON systems.

First, as noted above, existing arrangements of PON systems may face challenges due to DRBS. DRBS leads to back-reflection in the ODN fiber and depends on the Rayleigh backscattering recapture factor (S≈1.5×10⁻³), the Rayleigh backscattering field loss (α_{R}≈0.15 dB/km), the fiber loss (α≈0.2 dB/km), and the fiber length (l in km) as follows:

$$DRBS = {R}_{R B} = 2 S {α}_{R} \frac{1 - {e}^{- 4 α l}}{4 α} .$$

When the DRBS is plotted with respect to the fiber length, it may be seen that backreflected power is a saturating exponential that starts to increase rapidly with the fiber length and then achieves a value close to its asymptote at around 20 km. This backscattered power from the downstream signal spectrally overlaps with the received upstream signal on the upstream receiver and vice versa (backscattered power from the upstream signal spectrally overlaps with the received downstream signal on the downstream receiver).

In a coexistence system, the signal and reflection power at the central office and the user side can be analytically calculated. Here, an assumption is made that all drops are the same point reflections from the ODN are neglected. The SNR at the central office (upstream) and at user side (downstream) can then be calculated by adding the reflection, treated here as a noise component, to the intrinsic receiver noise. For a 28 GBd DP-QPSK with staircase forward error correction code (SC-FEC), a 9 dB SNR is required to have a net (post-FEC) throughput of 100 Gbit/s at a target sensitivity, or in other words to have the 100 Gbit/s system working. Based on plotting of the region where the SNR is above 9 dB for different launch powers at the central office and user side at various loss budgets, it may be seen that the area for bidirectional PON operation shrinks as loss budgets increase and eventually disappears for a 25 dB loss budget, which point bidirectional operation using the same wavelength is no longer possible as there is no overlap between the DS and US operating regimes. This shows that it is not possible for the 100 Gbit/s system to operate at the same wavelength in both the DS and the US over any conventional nominal PON ODN budget (e.g., N1=29 dB) due to distributed Rayleigh backscattering.

Second, as noted above, existing arrangements of PON systems may face challenges due to DRBS. Raman scattering is an inelastic process where an optical wave travelling in the fiber amplifies or depletes another optical wave travelling in the fiber, transferring the energy between waves. The amplified wave is called the signal and has lower optical frequency (higher wavelength) than the depleted wave, which is known as the pump (however, it should not be confused with their initial power, as a pump wave can have a lower power than the signal wave). The amplification or depletion depends on the separation in optical frequency (wavelength) between the pump and the signal. Since only the depletion of signals leads to outage of the PON systems, only the Raman depletion is considered here.

In legacy PON systems (XGS, 25GS, and 50G PON), the upstream wavelengths are usually chosen to be lower compared to the downstream wavelength, leading to the depletion of the upstream by the downstream within the same PON system, which is known as the self-induced depletion. This penalty is already inexplicitly accounted for in the optical path penalty (OPP) of respective PON systems. In the ODN, the strong downstream signals can deplete the upstream signals in the feeder fiber. The depletion in the drop fiber can be neglected as the downstream signal power significantly reduces in the drop due to the passive splitter as well as considering that drop fibers are usually relatively short. The Raman penalty due to the self-induced depletion for a 20 km feeder fiber is summarized for 25GS-PON and 50G-PON systems. For example, for DS wavelength of 1358 nm (25GS-PON), the Raman penalty is as follows: (1) for an US wavelength range of 1260-1280 the Raman penalty is 0.18-0.62, (2) for an US wavelength range of 1284-1288 the Raman penalty is 0.60-0.55, and (3) for an US wavelength range of 1290-1310 the Raman penalty is 0.53-0.28. For example, for DS wavelength of 1342 nm (50G-PON), the Raman penalty is as follows: (1) for an US wavelength range of 1260-1280 the Raman penalty is 0.63-0.47, (2) for an US wavelength range of 1284-1288 the Raman penalty is 0.41-0.36, and (3) for an US wavelength range of 1290-1310 the Raman penalty is 0.34-0.19. In both examples, due to large wavelength bands in the US, the penalty is given at both endpoints of the wavelength interval.

Additionally, when multiple PON systems coexist in the same ODN, this leads to additional penalty due to the interaction between multiple upstream and downstream signals of the multiple PON systems, which is known as coexistence-induced depletion and is not accounted for in the standards. So, if the operator has designed the ODN according to the loss budget and OPP in the standards and without much margin, the addition of other PON systems in a coexistence scenario could bring down the already existing PON system due to the coexistence-induced depletion. The coexistence-induced Raman depletion penalty in dB for an arbitrary O-band (upstream) wavelength may be further understood by considering an example in which the following three PON systems coexist: Very High Speed PON (VHSP) at 1320 nm with a launch power of 14 dBm (number aligned with current discussions in ITU-T), 50G-PON at 1342 nm/14 dBm (C+ class as per ITU-T G.9804.3) and 25GS-PON at 1358 nm/13 dBm (E2 class as per the 25GS-PON Specification v3.0). The Raman depletion penalty is as follows for the different PON systems over the 1260 nm-1330 nm US wavelength range: (1) for the 25G PON system, it starts at around 0.15 dB at 1260 nm, rises to around 0.5 dB between 1273 nm and 1282 nm, and then slowly decreases to around 0.1 dB at 1330 nm, (2) for the 50G PON system, it is around 0.6 dB between 1260 nm and 1268 nm, and then slowly decreases to around 0.1 dB at 1330 nm, and (3) for the VHSP PON system, it starts at around 0.5 dB and decreases until reaching 0 dB at 1320 nm. The wavelength band with the largest combined penalty is in the range 1260 nm-1280 nm, which is the upstream band for XGS-PON, as well as one of the options for 25GS and 50G upstream. Additionally, a graph of the combined SRS penalty in the triple PON coexistence scenario as a function of fiber length, evaluated at the worst-case wavelength of 1273 nm, is a curve through the following points: 0 dB at 0 km feeder fiber length, 0.6 dB at 5 km feeder fiber length, 0.95 dB at 10 km feeder fiber length, 1.2 dB at 15 km feeder fiber length, 1.4 dB at 20 km feeder fiber length, 1.5 dB at 25 km feeder fiber length, 1.55 dB at 30 km feeder fiber length, and so forth, levelling off around 1.6 dB for lengths of 35 km or longer.

The limitations due to back-reflection from the distributed Rayleigh scattering is typically overcome by ensuring that the downstream and upstream signals do not overlap in the optical spectrum, either by using different wavelengths for upstream and downstream or by using non-overlapping digital subcarriers with the same wavelength. However, these techniques reduce the spectral efficiency of the system by occupying double the optical spectrum compared to a single wavelength operation for both direction, which is not good especially when there is very little spectrum available in the O-band near the zero-dispersion wavelength for future use, e.g., for the next generation VHSP both downstream and upstream can use the same wavelength enabling operation at the zero-dispersion wavelength simultaneously for both direction and reuse of the same optical wavelength components (laser sources, filters and photodiodes) on the central office and user side. Furthermore, there is an additional penalty on top of the ODN loss budget both due to self-induced and coexistence-induced Raman depletion. For the case of self-induced Raman depletion, the penalty is included in the standards in the OPP along with the dispersion penalty; however, for the coexistence-induced Raman deletion, if the operator has no additional margin in their ODN, this may lead to the outage of the existing PON system.

As indicated hereinabove and discussed further hereinbelow, various example embodiments of the bidirectional optical communication capability may be configured to support bidirectional communications in a PON based on an optical core multiplex, including a set of optical fiber cores, disposed within the ODN (e.g., disposed on the feeder side of the passive optical splitter or the drop side of the passive optical splitter). The optical core multiplex may be configured to improve operation of the PON to reduce or even eliminate the detrimental effects of DRBS and/or Raman depletion in the feeder side of the ODN or the drop side of the ODN. The optical core multiplex may be configured to provide mitigation of the DRBS in the PON ODN to enable the use of same-wavelength bidirectional operation over PON loss budgets, mitigation of self-induced Raman depletion to provide additional margins for legacy PON systems, mitigation of coexistence-induced Raman depletion to avoid outage of existing PON systems when new PON systems are added to the ODN, or the like, as well as various combinations thereof. The implementation of the optical core multiplex within the feeder side of the ODN and the drop side of the ODN is discussed further below (e.g., with respect to FIGS. 1-6 for implementation of the optical core multiplex within the feeder side of the ODN and with respect to FIGS. 7-11 for implementation of the optical core multiplex within the drop side of the ODN for one or more of the ONUs served by the ODN).

Various example embodiments of the bidirectional optical communication capability, as indicated above, may be configured to support bidirectional communications in a PON based on a set of optical feeder cores disposed in the ODN between the OLTs and an optical splitter of the ODN. The set of optical feeder cores may include at least a first optical feeder core and a second optical feeder core. The set of optical feeder cores is configured to support communications of an optical system, where the optical system includes an optical channel pair including a downstream channel and an upstream channel, including supporting communications to satisfy a condition in which the downstream channel is absent in at least one of the optical feeder cores in which the upstream channel is present and supporting communications such that one of the optical feeder cores where the condition is fulfilled is used for active upstream reception. The first and second optical feeder cores may be disposed in different optical fibers or the same optical fiber. The downstream optical signals and the upstream optical signals may have a common wavelength, and downstream optical signals may have a first transmit power and the upstream optical signals may have a second transmit power lower than the first transmit power. The set of optical feeder cores may include one or more additional optical feeder cores which may be used for protection of the first and second optical feeder cores. The set of optical feeder cores may be deployed within the ODN in various ways (e.g., using a single directional splitter deployed between network-side ends of the optical feeder cores and the OLT(s) with the user-side ends of the optical feeder cores being directly connected to the optical splitter, using a pair of directional splitters including a first directional splitter deployed between network-side ends of the optical feeder cores and the OLT(s) and a second directional splitter deployed between the user-side ends of the optical feeder cores and the optical splitter, without using any directional splitters between the OLT(s) and the optical splitter, or the like). It will be appreciated that at least some such example embodiments may be further understood by way of reference to FIGS. 1-6.

FIG. 1 depicts an example embodiment of a passive optical network configured to support bidirectional optical communication based on an optical feeder section including multiple optical feeder cores.

As depicted in FIG. 1, the PON 100 includes a central office (CO) 110 of a PON operator and a set of user locations (ULs) 120 of a set of users of the PON operator, where the CO 110 and the ULs 120 are interconnected by an optical distribution network (ODN) 130. The PON 100 is a coexistence PON supporting multiple types of PON systems between the CO 110 and the ULs 120 over the common ODN 130. For example, the PON 100 is illustrated as supporting an XGS PON system, a 25GS/50G PON system, and a VHSP PON system for supporting users on different PON systems, as well as a point-to-point (P2P) PON overlay configured to provide users with dedicated high-speed service.

The CO 110 includes an XGS OLT 111 configured to support communications based on XGS PON, a 25GS/50G OLT 112 configured to support communications based on 25GS/50G PON, and a VHSP OLT 113 configured to support communications based on VHSP PON. The CO 110 also includes a pair of coherent transceivers 114-1 and 114-2 (collectively, coherent transceivers 114) which are configured to provide two corresponding users with dedicated high-speed service based on a P2P PON overlay. The coherent transceivers 114 are connected to a multiplexer 115 for supporting the P2P PON overlay. The CO 110 also includes a coexistence element (CE) 119 connected to the XGS OLT 111, the 25GS/50G OLT 112, and the VHSP OLT 113 for supporting coexistence of the various PON systems over the ODN 130 and which is also connected to the multiplexer 115 for supporting the P2P PON overlay over the ODN 130. In this manner, the CO 110 is configured to support a coexistence scenario in which user devices operating on different PON systems and having dedicated P2P PON overlays may be supported over the common ODN 130. It will be appreciated that the CO 110 may include various other elements configured to support optical communications via the PON 100.

The ULs 120 support a set of user devices 121-1 to 121-N (collectively, user devices 121), which include ONUs operating on different PON systems and coherent transceivers for the P2P PON overlay. More specifically, the set of user devices 121 includes an XGS ONU 121-1 configured to communicate with the XGS OLT 111, an XGS ONU 121-2 configured to communicate with the XGS OLT 111, a coherent transceiver 121-3 configured to communicate with the coherent transceiver 114-1, a 25GS/50G ONU 121-4 configured to communicate with the 25GS/50G OLT 112, a VHSP ONU 121-5 configured to communicate with the VHSP OLT 113, an XGS ONU 121-6 configured to communicate with the XGS OLT 111, a coherent transceiver 121-7 configured to communicate with the coherent transceiver 114-2, a VHSP ONU 121-8 configured to communicate with the VHSP OLT 113, and a 25GS/50G ONU 121-N configured to communicate with the 25GS/50G OLT 112. It may be seen that the CO 110 is configured to support a coexistence scenario in which the user devices 121 operating on different PON systems and having dedicated P2P PON overlays may be supported over the common ODN 130. It will be appreciated that the ULs 120 may include various other user locations with various other user devices 121 which may obtain network access through the PON 100.

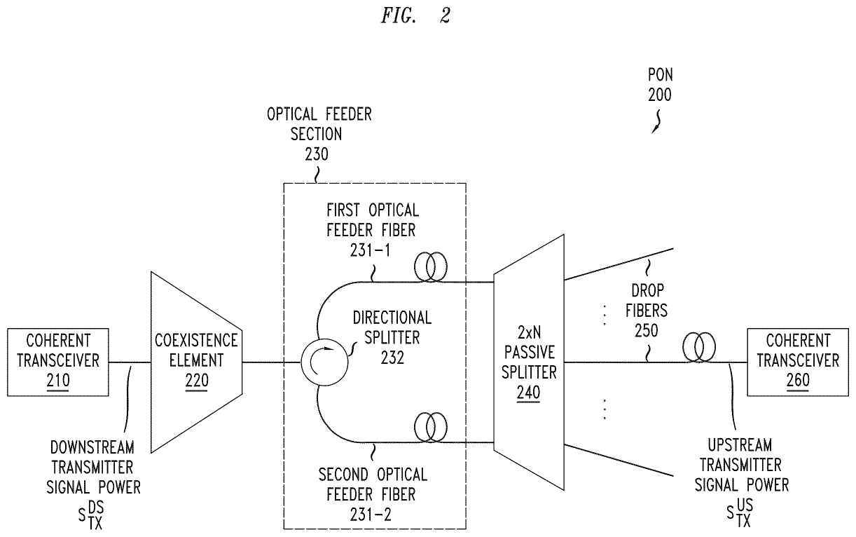

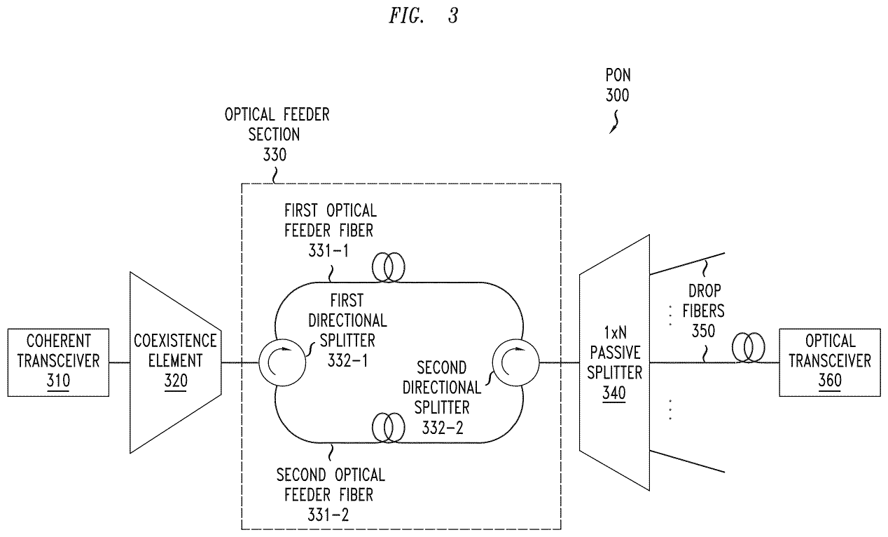

The ODN 130 operates as a point-to-multipoint (P2MP) architecture between the CE 119 of the CO 110 and the user devices 121 of the ULs 120 based on one or more passive splitters and various optical fibers disposed within the ODN 130. The one or more passive splitters, for simplicity and without loss of generality, are illustrated as a single M×N passive splitter 135, where M≥1. The ODN 130 includes an optical feeder section 131 disposed between CE 119 and the M×N passive splitter 135. The optical feeder section 131 between CE 119 and the M×N passive splitter 135 may be implemented in various ways (e.g., in terms of elements of which it is composed, the manner in which it is connected to the CE 119 and the M×N passive splitter 135, and so forth), at least some of which are discussed further below and at least some example embodiments of which are presented with respect to FIGS. 2-4. The optical feeder section 131 is configured to provide various improvements for bidirectional optical communications within the ODN 130, such as by supporting bidirectional communication while mitigating DRBS and Raman depletion (including self-induced Raman depletion and coexistence-induced Raman depletion), supporting bidirectional communication on a common wavelength, and so forth. The ODN includes a set of drop fibers 139-1 to 139-N disposed between the M×N passive splitter 135 and the user devices 121-1 to 121-N, respectively. It will be appreciated that the ODN 130 may include various other elements configured to support optical communications within the PON 100.

The optical feeder section 131, as indicated above, may be implemented in various ways. The optical feeder section 131 includes a set of optical feeder cores 132. The set of optical feeder cores 132 includes at least a first optical feeder core and a second optical feeder core. In the DS direction, DS optical signals from the CO 110 toward the ULs 120 are propagated only on one of the optical feeder cores (e.g., only on the first optical feeder core or only on the second optical feeder core) or a first portion of DS optical signals from the CO 110 toward the ULs 120 are propagated on the first optical feeder core and a remaining portion of DS optical signals from the CO 110 toward the ULs 120 are propagated on the second optical feeder core. In the US direction, US optical signals from the ULs 120 toward the CO 110 are propagated only on the second optical feeder core or US optical signals from the ULs 120 toward the CO 110 are propagated on both the first optical feeder core and the second optical feeder core. The set of optical feeder cores 132 also may include one or more additional optical feeder cores 132 which may be used for protection in case of failure of the first optical feeder core or the second optical feeder core. The set of optical feeder cores 132 may include two or more optical fibers (e.g., each optical feeder core is a separate single-mode optical fiber), two or more cores of the same optical fiber (e.g., each optical feeder core is a different core of the same multi-mode optical fiber), two or more cores of two or more different optical fibers, or the like, as well as various combinations thereof. The set of optical feeder cores 132 may be connected to the CE 119 and the M×N passive splitter 135 in various ways (e.g., directly, via one or more directional splitters, or the like, as well as various combinations thereof), at least some example embodiments of which are presented with respect to FIGS. 2-4. It will be appreciated that the optical feeder section 131 may include various other elements configured to support bidirectional optical communications within the ODN 130.

The optical feeder section 131, as indicated above, is configured to provide various improvements for bidirectional optical communications between the CO 110 and the ULs 120 via the ODN 130. For example, the optical feeder section 131 may be configured to mitigate DRBS and Raman depletion (including self-induced Raman depletion and coexistence-induced Raman depletion) between the CE 119 and the M×N passive splitter 135. For example, the optical feeder section 131 may be configured to enable operation of the DS and the US with asymmetric launch powers (e.g., using a launch power at the central office side that is higher than the launch power at the user side) in order to achieve bidirectional transmission on the same wavelength rather than having to use different wavelengths for the DS and US directions, thereby allowing achievement of high loss budget by overcoming DRBS as well as mitigating both the self-induced and coexistence-induced Raman depletions, and potentially other inter-channel effects, between transmission directions and/or wavelength bands. It will be appreciated that the optical feeder section 131 may be configured to provide various other improvements for bidirectional optical communications within the ODN 130.

FIG. 2 depicts an example embodiment of a portion of a PON having an optical feeder section including multiple optical feeder cores where the optical feeder cores are disposed in a pair of optical feeder fibers and where network-side ends of the optical fibers are connected to a directional splitter and user-side ends of the optical fibers are connected to a passive splitter.

As depicted in FIG. 2, a PON 200 includes a coherent transceiver 210, a co-existence element (CE) 220, an optical feeder section 230, a 2×N passive splitter 240, and a set of drop fibers 250 to a set of ONUs (only one of which is depicted as coherent transceiver 260, for purposes of clarity). The optical feeder section 230 includes a pair of optical feeder fibers 231 including a first optical feeder fiber 231-1 and a second optical feeder fiber 231-2, and a directional splitter 232 disposed between the CE 220 and the optical feeder fibers 231. The network-side ends of the optical feeder fibers 231 are connected to the directional splitter 232 and the user-side ends of the optical feeder fibers 231 are connected to the two network-side ports of the 2×N passive splitter 240.

In the DS direction, the DS optical signals from the user side of the CE 220 may be directed, by the directional splitter 232, to propagate only over the first optical feeder fiber 231-1 and not over second optical feeder fiber 231-2. The DS optical signals are then received only by the first of the two network-side ports of the 2×N passive splitter 240 over the first optical feeder fiber 231-1 but not received by the second of the two network-side ports of the 2×N passive splitter 240 over the second optical feeder fiber 231-2. The DS optical signals then propagate over the drop fibers 250 toward the associated ONUs (illustratively, coherent transceiver 260).

In the DS direction, the DS optical signals from the user side of the CE 220 may be directed, by the directional splitter 232, such that a first portion of DS optical signals from the user side of the CE 220 propagate over the first optical feeder fiber 231-1 and a remaining portion of the DS optical signals from the user side of the CE 220 propagate over second optical feeder fiber 231-2. The DS optical signals are then received by both the first of the two network-side ports of the 2×N passive splitter 240 over the first optical feeder fiber 231-1 and by the second of the two network-side ports of the 2×N passive splitter 240 over the second optical feeder fiber 231-2. The DS optical signals then propagate over the drop fibers 250 toward the associated ONUs (illustratively, coherent transceiver 260).

In the US direction, the US optical signals output by the network side of the 2×N passive splitter 240 are directed by the first of the two network-side ports of the 2×N passive splitter 240 to propagate over the first optical feeder fiber 231-1 and directed by the second of the two network-side ports of the 2×N passive splitter 240 to propagate over the second optical feeder fiber 231-2. The US optical signals are then received by the directional splitter 232 via the optical feeder fibers 231 and the directional splitter 232 directs the US optical signals to the CE 220 for propagation toward the OLT (illustratively, coherent transceiver 210).

In FIG. 2, calculation of the signal power and the reflected power at the central office side (line termination) receiver and the user side (user termination) receiver for the dual optical feeder fiber arrangement are depicted. As discussed further below, the use of the dual optical feeder fibers 231 in the optical feeder section 230 can reduce or even eliminate the detrimental effects of DRBS and/or Raman depletion in a manner that improves the operation of the PON.

At the central office side, the upstream received signal power

$$( {S}_{R X}^{U S} )$$

and the upstream reflected power

$$( {R}_{R X}^{U S} )$$

may be calculated as follows. The upstream received signal power

$$( {S}_{R X}^{U S} )$$

may be calculated as

$${S}_{R X}^{U S} = \frac{{S}_{T X}^{U S}}{{L}_{C E} {L}_{c i r c} {L}_{F F} {L}_{S} {L}_{D F} {L}_{A}} ,$$

where

$${S}_{TX}^{U S}$$

is the upstream transmitted signal power, L_{CE} is the loss in the CE 220, L_{circ} is the loss in the directional splitter 232 (e.g., circulator loss), L_{FF} is the loss in the optical feeder fibers 231, L_{S} is the loss in the 2×N passive splitter 240, L_{DF} is the loss in the drop fiber 250, and L_{A} is the additional loss between the coherent transceiver 260 and the coherent transceiver 210. The upstream reflected power

$$( {R}_{R X}^{U S} )$$

may be calculated as

$${R}_{RX}^{US} = \frac{{S}_{TX}^{DS} {RB}_{DF}}{{L}_{CE}^{2} {L}_{circ}^{2} {L}_{FF}^{2} {L}_{S} {L}_{A}} ,$$

where

$${S}_{T X}^{D S}$$

is the downstream transmitted signal power, RB_{DF} is the Rayleigh backscattering power, L_{CE} is the loss in the CE 220, L_{FF} is the loss in the optical feeder fibers 231, L_{S} is the loss in the 2×N passive splitter 240, and L_{A} is the additional loss between the coherent transceiver 260 and the coherent transceiver 210. It will be appreciated that this represents reductions in the upstream received signal power

$$( {S}_{R X}^{U S} )$$

and the upstream reflected power

$$( {R}_{R X}^{U S} )$$

as compared with the case in which there is a single feeder fiber disposed between the OLT and the passive splitter, which may be calculated as

$${S}_{R X}^{U S} = \frac{{S}_{T X}^{US}}{{L}_{C E} {L}_{F F} {L}_{S} {L}_{D F} {L}_{A}} and {R}_{R X}^{U S} = \frac{{S}_{T X}^{D S} {RB}_{FF}}{{L}_{CE}^{2}} + \frac{{S}_{T X}^{D S} {RB}_{DF}}{{L}_{CE}^{2} {L}_{FF}^{2} {L}_{S} {L}_{A}} ,$$

respectively.

At the user side, the downstream received signal power

$$( {S}_{R X}^{D S} )$$

and the downstream reflected power

$$( {R}_{R X}^{D S} )$$

may be calculated as follows. The downstream received signal power (S_{RX}^{DS}) may be calculated as

$${S}_{R X}^{D S} = \frac{{S}_{T X}^{D S}}{{L}_{C E} {L}_{c i r c} {L}_{F F} {L}_{S} {L}_{D F} {L}_{A}} ,$$

where

$${S}_{T X}^{D S}$$

is the downstream transmitted signal power, L_{CE} is the loss in the CE 220, L_{circ} is the loss in the directional splitter 232 (e.g., circulator loss), L_{FF} is the loss in the optical feeder fibers 231, L_{S} is the loss in the 2×N passive splitter 240, L_{DF} is the loss in the drop fiber 250, and L_{A} is the additional loss between the coherent transceiver 260 and the coherent transceiver 210. The downstream reflected power

$$( {R}_{R X}^{D S} )$$

may be calculated as

$${R}_{R X}^{DS} = {S}_{TX}^{US} {RB}_{DF} + \frac{2 {S}_{TX}^{US} {RB}_{FF}}{{L}_{DF}^{2} {L}_{S}^{2} {L}_{A}^{2}} ,$$

where

$${S}_{T X}^{U S}$$

is the upstream transmitted signal power, RB_{DF} is the Rayleigh backscattering power on the drop fiber 250, RB_{FF} is the Rayleigh backscattering power in the optical feeder fibers 231, L_{DF} is the loss in the drop fiber 250, L_{S} is the loss in the 2×N passive splitter 240, and L_{A} is the additional loss between the coherent transceiver 260 and the coherent transceiver 210. It will be appreciated that this represents reductions in the downstream received signal power.

$$( {S}_{R X}^{D S} )$$

and the downstream reflected power

$$( {R}_{R X}^{D S} )$$

as compared with the case in which there is a single feeder fiber disposed between the OLT and the passive splitter, which may be calculated as

$${S}_{R X}^{D S} = \frac{{S}_{T X}^{D S}}{{L}_{C E} {L}_{F F} {L}_{S} {L}_{D F} {L}_{A}} and {R}_{R X}^{DS} = {S}_{TX}^{US} {RB}_{DF} + \frac{{S}_{TX}^{US} {RB}_{FF}}{{L}_{DF}^{2} {L}_{S}^{2} {L}_{A}^{2}} ,$$

respectively.

FIG. 3 depicts an example embodiment of a portion of a PON having an optical feeder section including multiple optical feeder cores where the optical feeder cores are disposed in a pair of optical feeder fibers and where network-side ends of the optical fibers are connected to a first directional splitter and user-side ends of the optical fibers are connected to a second directional splitter.

As depicted in FIG. 3, a PON 300 includes a coherent transceiver 310, a co-existence element (CE) 320, an optical feeder section 330, a 1×N passive splitter 340, and a set of drop fibers 350 to a set of ONUs (only one of which is depicted as coherent transceiver 360, for purposes of clarity). The optical feeder section 330 includes a pair of optical feeder fibers 331 including a first optical feeder fiber 331-1 and a second optical feeder fiber 331-2, and a pair of directional splitters 332 including a first directional splitter 332-1 disposed between the CE 320 and the optical feeder fibers 331 and a second directional splitter 332-2 disposed between the 1×N passive splitter 340 and the optical feeder fibers 331. The network-side ends of the optical feeder fibers 331 are connected to the first directional splitter 332-1 and the user-side ends of the optical feeder fibers 331 are connected to the second directional splitter 332-2.

In the DS direction, the DS optical signals from the user side of the CE 320 may be directed, by the first directional splitter 332-1, to propagate only over the first optical feeder fiber 331-1 and not over second optical feeder fiber 331-2. The DS optical signals are then received by the second directional splitter 332-2 over the first optical feeder fiber 331-1 and directed to the network-side port of the 1×N passive splitter 340. The DS optical signals then propagate over the drop fibers 350 toward the associated ONUs (illustratively, coherent transceiver 360).

In the DS direction, the DS optical signals from the user side of the CE 320 may be directed, by the first directional splitter 332-1, such that a first portion of DS optical signals from the user side of the CE 320 propagate over the first optical feeder fiber 331-1 and a remaining portion of the DS optical signals from the user side of the CE 320 propagate over second optical feeder fiber 331-2. The DS optical signals are then received by the second directional splitter 332-2 over the first optical feeder fiber 331-1 and over the second optical feeder fiber 331-2, and directed to the network-side port of the 1×N passive splitter 340. The DS optical signals then propagate over the drop fibers 350 toward the associated ONUs (illustratively, coherent transceiver 360).

In the US direction, the US optical signals output by the network side of the 1×N passive splitter 340 are directed to the second directional splitter 332-2. The second directional splitter 332-2 receives the US optical signals and directs the US optical signals to propagate only over the second optical feeder fiber 331-2. The US optical signals are then received by the first directional splitter 332-1 via the second optical feeder fiber 331-2 and the first directional splitter 332-1 directs the US optical signals to the CE 320 for propagation toward the OLT (illustratively, coherent transceiver 310).

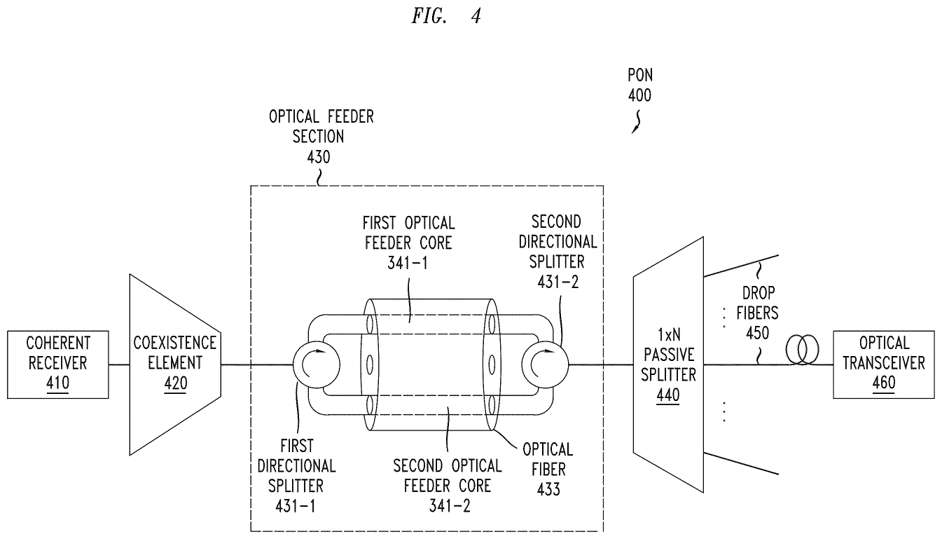

FIG. 4 depicts an example embodiment of a portion of a PON having an optical feeder section including multiple optical feeder cores where the optical feeder cores are disposed in a single multi-core optical feeder fiber and where network-side ends of the optical feeder cores are connected to a first directional splitter and user-side ends of the optical feeder cores are connected to a second directional splitter.

As depicted in FIG. 4, a PON 400 includes a coherent transceiver 410, a co-existence element (CE) 420, an optical feeder section 430, a 1×N passive splitter 440, and a set of drop fibers 450 to a set of ONUs (only one of which is depicted as coherent transceiver 460, for purposes of clarity). The optical feeder section 430 includes a pair of optical feeder cores 431 including a first optical feeder core 431-1 and a second optical feeder core 431-2 disposed within a multi-core optical fiber 433, and a pair of directional splitters 432 including a first directional splitter 432-1 disposed between the CE 420 and the optical feeder cores 431 and a second directional splitter 432-2 disposed between the 1×N passive splitter 440 and the optical feeder cores 431. The network-side ends of the optical feeder cores 431 are connected to the first directional splitter 432-1 and the user-side ends of the optical feeder cores 431 are connected to the second directional splitter 432-2.

In the DS direction, the DS optical signals from the user side of the CE 420 are directed, by the first directional splitter 432-1, to propagate only over the first optical feeder core 431-1 and not over second optical feeder core 431-2. The DS optical signals are then received by the second directional splitter 432-2 over the first optical feeder core 431-1 and directed to the network-side port of the 1×N passive splitter 440. The DS optical signals then propagate over the drop fibers 450 toward the associated ONUs (illustratively, coherent transceiver 460).

In the US direction, the US optical signals output by the network side of the 1×N passive splitter 340 are directed to the second directional splitter 432-2. The second directional splitter 432-2 receives the US optical signals and directs the US optical signals to propagate only over the second optical feeder core 431-2. The US optical signals are then received by the first directional splitter 432-1 via the second optical feeder core 431-2 and the first directional splitter 432-1 directs the US optical signals to the CE 420 for propagation toward the OLT (illustratively, coherent transceiver 410).

It will be appreciated that, although primarily presented with respect to example embodiments of an optical feeder section including multiple optical feeder cores disposed in a single multi-core optical feeder fiber where two directional splitters are used at the ends of the optical feeder cores, in at least some example embodiments of an optical feeder section including multiple optical feeder cores disposed in a single multi-core optical feeder fiber only a single directional splitter may be used in the optical feeder section (e.g., a single directional splitter disposed between the network-side ends of the optical feeder cores, while the user-side ends of the optical feeder cores are directly connected to a 2×N passive optical splitter without use of a directional splitter). It will be appreciated that this would be an arrangement similar to the arrangement of FIG. 2, but where the multiple optical feeder cores are disposed in a single multi-core optical feeder fiber (as in the arrangement of FIG. 4) rather than being implemented as two separate optical feeder fibers (as in the arrangement of FIG. 2).

It will be appreciated that, although primarily presented with respect to specific example embodiments of the optical feeder section (e.g., number of optical fiber cores that are used as feeder lines, number of optical fibers in which the optical fiber cores are disposed depending on whether single-core fibers and/or multi-core fibers are used, whether or not directional splitters are used on the network side and/or the user side of the optical feeder section, and so forth), the optical feeder section may be configured in other ways to utilize multiple optical feeder cores for improved communications within passive optical networks.

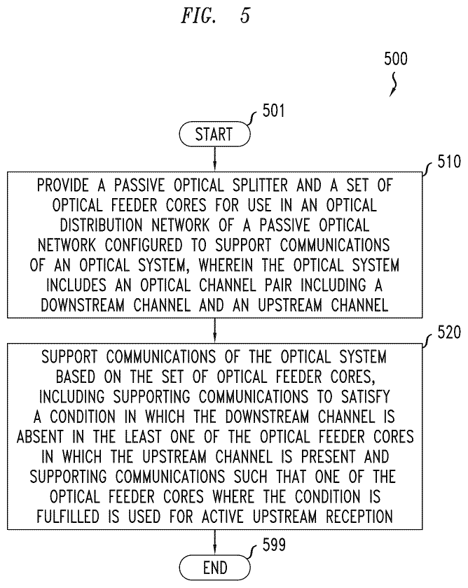

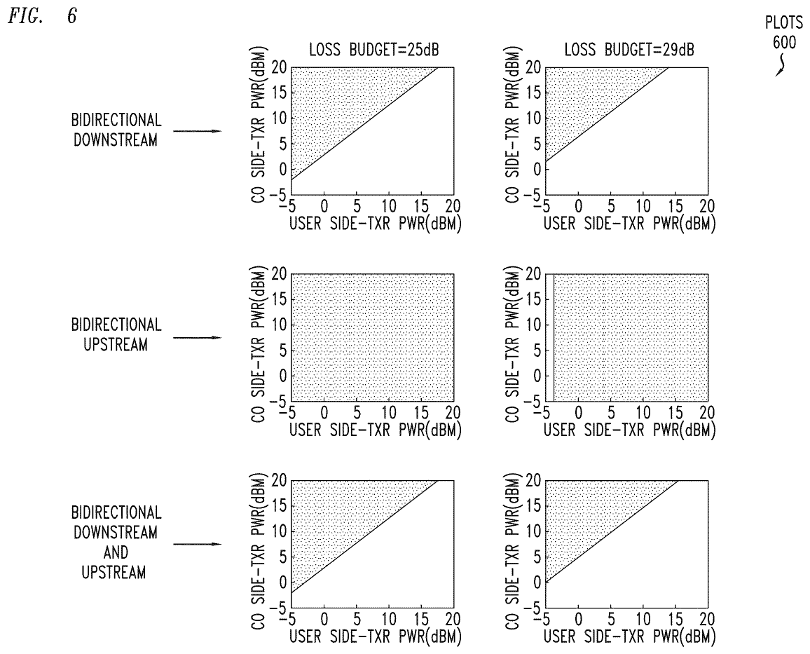

FIG. 5 depicts an example embodiment of a method for supporting bidirectional optical communications in a PON based on use of a set of optical feeder cores in an ODN of the PON. It will be appreciated that, although primarily presented herein as being performed serially, at least a portion of the functions of method 500 may be performed contemporaneously or in a different order than as presented in FIG. 5. At block 501, the method 500 begins. At block 510, provide a passive optical splitter and a set of optical feeder cores for use in an optical distribution network of a passive optical network configured to support communications of an optical system, where the optical system includes an optical channel pair including a downstream channel and an upstream channel. At block 520, support communications of the optical system based on the set of optical feeder cores, including supporting communications to satisfy a condition in which the downstream channel is absent in at least one of the optical feeder cores in which the upstream channel is present and supporting communications such that one of the optical feeder cores where the condition is fulfilled is used for active upstream reception. At block 599, the method 500 ends.

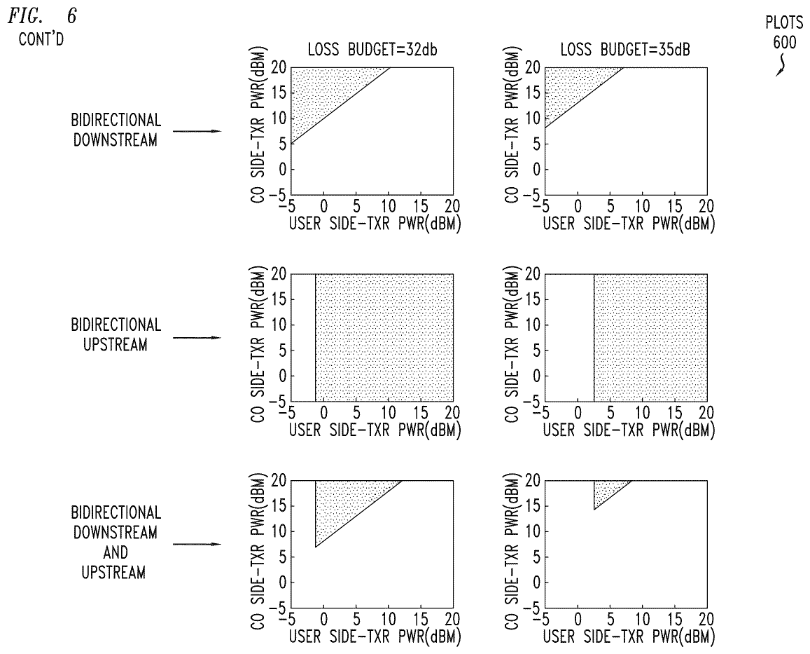

FIG. 6 depicts a set of plots of operation of the downstream, the upstream, and a combination of the downstream and the upstream for different launch powers at the central office side and the user side as well as various loss budgets. As depicted in FIG. 6, in the plots 600 the operational regions for the downstream, the upstream, and a combination of the downstream and the upstream at 100 Gbit/s for four different loss budgets (25 dB, 29 dB, 32 dB, and 35 dB) are illustrated using shading. In the downstream direction (top row) and upstream direction (middle row), it may be seen that the region of operation shrinks as the loss budget increases. The bottom row represents the overlap between the top row and the middle row, showing the region of operation in which both the downstream and upstream are able to operate for the different loss budgets.

As depicted in FIG. 6, it may be seen that the use of dual feeder fibers as well as higher launch powers at the central office side compared to the launch powers at the user side enables simultaneous operation of both upstream and downstream at the same wavelength for PON loss budget of more than 30 dB (as opposed to the case of a single optical feeder fiber in the optical feeder section, where even at a loss budget of 21 dB there is a relatively narrow range of operation, the range of operation is even narrower at a loss budget of 23 dB, and the range of operation complete disappears at a loss budget of 25 dB).

Various example embodiments of the bidirectional optical communication capability, as indicated above, may be configured to support bidirectional communications in a PON based on a set of optical drop cores disposed in the ODN between an optical splitter of the ODN and an ONU. The set of optical drop cores may include at least a first optical drop core and a second optical drop core. The set of optical drop cores is configured to support communications of an optical system, where the optical system includes an optical channel pair including a downstream channel and an upstream channel, including supporting communications to satisfy a condition in which the upstream channel is absent in at least one of the optical drop cores in which the downstream channel is present and supporting communications such that one of the optical drop cores where the condition is fulfilled is used for active downstream reception. The first and second optical drop cores may be disposed in different optical fibers or the same optical fiber. The downstream optical signals and the upstream optical signals may have a common wavelength, and downstream optical signals may have a first transmit power and the upstream optical signals may have a second transmit power greater than the first transmit power. The set of optical drop cores may include one or more additional optical drop cores which may be used for protection of the first and second optical drop cores. The set of optical drop cores may be deployed within the ODN in various ways (e.g., with or without using a directional splitter between optical splitter and the ONU, with or without using one or more additional splitters between the optical splitter and the ONU, or the like, as well as various combinations thereof). It will be appreciated that at least some such example embodiments may be further understood by way of reference to FIGS. 7-11.

FIG. 7 depicts an example embodiment of a portion of a PON including an ODN where the ODN includes a pair of optical drop cores supporting an ONU of the PON, and where a first of the optical drop cores is connected to a passive optical splitter of the ODN and connected to the ONU and where a second optical drop core also is connected to the passive optical splitter of the ODN and connected to the ONU. As depicted in FIG. 7, in PON 700 one of the ONUs 710 is communicatively connected to a passive optical splitter 720 via a pair of optical drop cores 730. The pair of optical drop cores 730 is a duplex fiber, with both of the optical drop cores 730 being connected to the ONU 710 and to the drop side of the passive optical splitter 720. In this arrangement, the DS signals and US signals may be propagated in various ways (e.g., the US channel is absent in at least one of the optical drop cores 730 in which the DS channel is present and one of the optical drop cores 730 where the US is absent is used for active DS reception). It will be appreciated that, although omitted for purposes of clarity, a directional splitter may be disposed between the network-side ends of the optical drop cores 730 and the passive optical splitter 720 such that only a single port of the drop side of the passive optical splitter 720 is used to support communications of the ONU 710. It will be appreciated that, although primarily present with respect to a case in which only one of the ONUs is utilizing an optical core multiplex with multiple optical drop cores, any of the ONUs may utilize an optical core multiplex with multiple optical drop cores to support improved bidirectional communications in the PON 700.

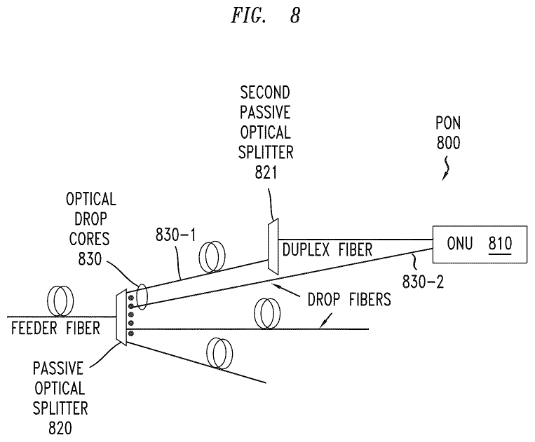

FIG. 8 depicts an example embodiment of a portion of a PON including an ODN where the ODN includes a pair of optical drop cores supporting an ONU of the PON, and where a first optical drop core is connected to a passive optical splitter associated with a feeder section of the ODN and connected to a second passive optical splitter disposed between the passive optical splitter and the ONU and where a second optical drop core is connected to the passive optical splitter associated with the feeder section of the ODN and connected to the ONU. As depicted in FIG. 8, in PON 800 one of the ONUs 810 is communicatively connected to a passive optical splitter 820 via a pair of optical drop cores 830. The pair of optical drop cores 830 includes (1) a first optical drop core 830-1 connected to the drop side of the passive optical splitter 820 and connected to a second passive optical splitter 821 disposed between the passive optical splitter 820 and the ONU 810 such that the ONU 810 is directly connected to the second passive optical splitter 821 and (2) a second optical drop core 830-2 connected to the drop side of the passive optical splitter 820 and connected to the ONU 810 (without use of an intermediate passive optical splitter). In this arrangement, the DS signals and US signals may be propagated in various ways (e.g., the US channel is absent in at least one of the optical drop cores 830 in which the DS channel is present and one of the optical drop cores 830 where the US is absent is used for active DS reception). It will be appreciated that, although omitted for purposes of clarity, a directional splitter may be disposed between the network-side ends of the optical drop cores 830 and the passive optical splitter 820 such that only a single port of the drop side of the passive optical splitter 820 is used to support communications of the ONU 810. It will be appreciated that, although primarily present with respect to a case in which only one of the ONUs is utilizing an optical core multiplex with multiple optical drop cores, any of the ONUs may utilize an optical core multiplex with multiple optical drop cores to support improved bidirectional communications in the PON 800.

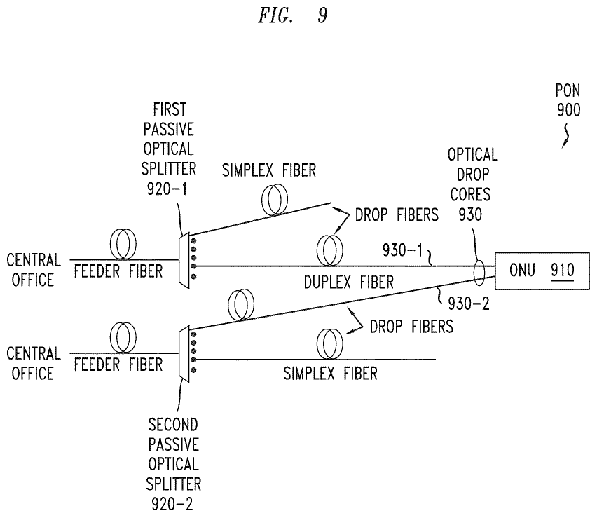

FIG. 9 depicts an example embodiment of a portion of a PON including an ODN where the ODN includes a pair of optical drop cores supporting an ONU of the PON, and where a first of the optical drop cores is connected to a first passive optical splitter of the ODN and connected to the ONU and where a second of the optical drop cores is connected to a second passive optical splitter of the ODN and is connected to the ONU. As depicted in FIG. 9, in PON 900 one of the ONUs 910 is communicatively connected to a pair of passive optical splitters 920 via a pair of optical drop cores 930. The pair of passive optical splitters 920 includes a first passive optical splitter 920-1 associated with a first central office and a second passive optical splitter 920-2 associated with a second central office. The pair of optical drop cores 930 includes (1) a first optical drop core 930-1 connected to the drop side of the first passive optical splitter 920-1 and connected to the ONU 910 and (2) a second optical drop core 930-2 connected to the drop side of the second passive optical splitter 920-2 and connected to the ONU 910. In this arrangement, the DS signals and US signals may be propagated in various ways (e.g., the US channel is absent in at least one of the optical drop cores 930 in which the DS channel is present and one of the optical drop cores 930 where the US is absent is used for active DS reception). It will be appreciated that, although omitted for purposes of clarity, a directional splitter may be disposed between the user-side ends of the optical drop cores 930 and the ONU 910 such that only a single port of the ONU 910 is used to support communications of the ONU 910. It will be appreciated that, although primarily present with respect to a case in which only one of the ONUs is utilizing an optical core multiplex with multiple optical drop cores, any of the ONUs may utilize an optical core multiplex with multiple optical drop cores to support improved bidirectional communications in the PON 900.

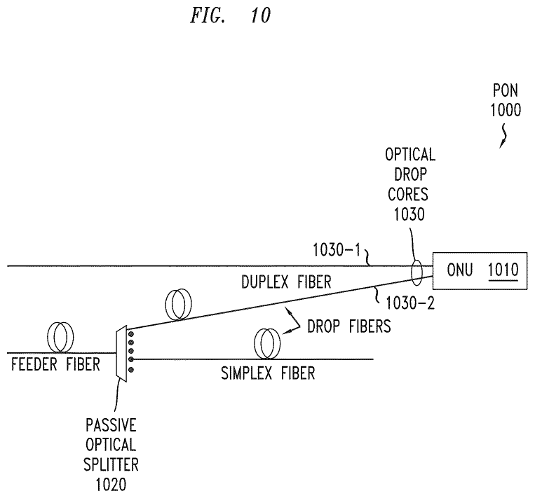

FIG. 10 depicts an example embodiment of a portion of a PON including an ODN where the ODN includes a pair of optical drop cores supporting an ONU of the PON, and where a first of the optical drop cores is connected to a first passive optical splitter of the ODN and connected to the ONU and where a second of the optical drop cores is connected to a second passive optical splitter of the ODN and is connected to the ONU. As depicted in FIG. 10, in PON 1000 one of the ONUs 1010 is communicatively connected to a central office (omitted for purposes of clarity) via a pair of optical drop cores 1030. The pair of optical drop cores 1030 includes (1) a first optical drop core 1030-1 connected to the central office as a dedicated optical fiber from the central office to the ONU 1010 and (2) a second optical drop core 1030-2 connected to the drop side of a passive optical splitter 1020 and connected to the ONU 1010. In this arrangement, the DS signals and US signals may be propagated in various ways (e.g., the DS signals may be propagated on the first optical drop core 1030-1 while the US signals may be propagated on the second optical drop core 1030-2, the DS signals may be propagated on the second optical drop core 1030-2 while the US signals are propagated on the first optical drop core 1030-1, and so forth). It will be appreciated that, although primarily present with respect to a case in which only one of the ONUs is utilizing an optical core multiplex with multiple optical drop cores, any of the ONUs may utilize an optical core multiplex with multiple optical drop cores to support improved bidirectional communications in the PON 900.

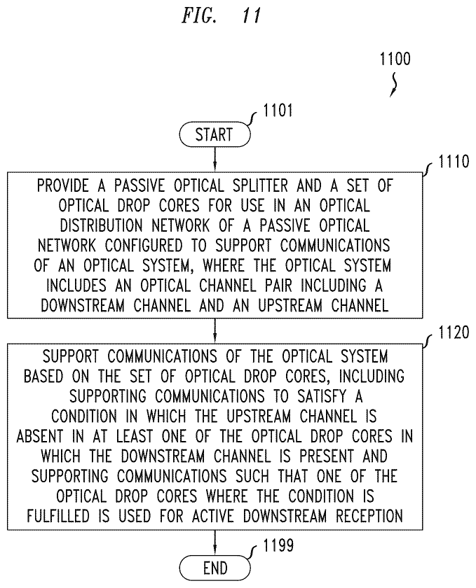

FIG. 11 depicts an example embodiment of a method for supporting bidirectional optical communications in a PON based on use of a set of optical drop cores in an ODN of the PON. It will be appreciated that, although primarily presented herein as being performed serially, at least a portion of the functions of method 1100 may be performed contemporaneously or in a different order than as presented in FIG. 11. At block 1101, the method 1100 begins. At block 1110, provide a passive optical splitter and a set of optical drop cores for use in an optical distribution network of a passive optical network configured to support communications of an optical system, wherein the optical system includes an optical channel pair including a downstream channel and an upstream channel. At block 1120, support communications of the optical system based on the set of optical drop cores, including supporting communications to satisfy a condition in which the upstream channel is absent in at least one of the optical drop cores in which the downstream channel is present and supporting communications such that one of the optical drop cores where the condition is fulfilled is used for active downstream reception. At block 1199, the method 1100 ends.

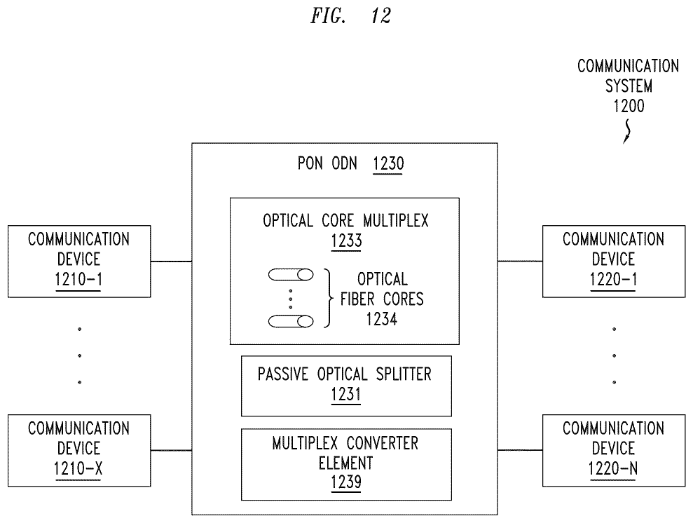

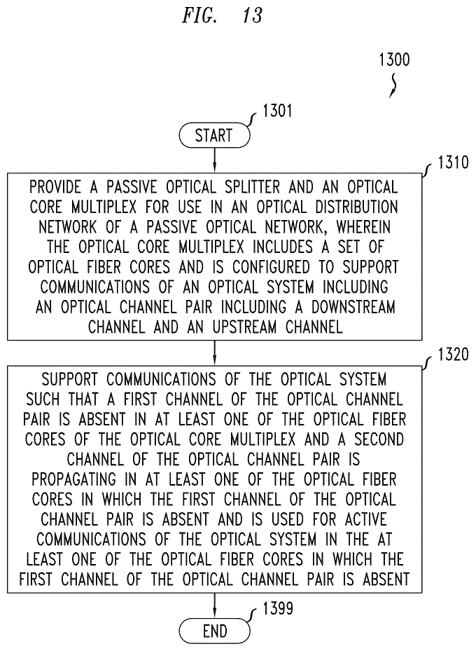

It will be appreciated that, although primarily presented with respect to supporting bidirectional optical communications in a particular communication context (namely, within a PON system for supporting bidirectional communications between a set of OLTs on the feeder side and a set of ONUs on the drop side), bidirectional optical communications may be supported within various other communication contexts (e.g., within one or more other point-to-multipoint communication contexts which may utilize a PON ODN for communications between sets of communication devices, within one or more point-to-point communication contexts which may utilize a PON ODN architecture for communications between communication devices, or the like, as well as various combinations thereof). It will be appreciate that such communication contexts within which various example embodiments of the bidirectional optical communications may be employed may be further understood by way of reference to FIGS. 12 and 13, which provide a more generic representation of various example embodiments presented herein.

FIG. 12 depicts an example embodiment of a communication system including a PON ODN configured to support bidirectional optical communications based on a combination of a passive optical splitter and an optical core multiplex including a set of optical fiber cores configured to support optical communications within the PON ODN.

As depicted in FIG. 12, a communication system 1200 includes a set of communication devices 1210-1 to 1210-X (collectively, communication devices 1210) and a set of communication devices 1220-1 to 1220-N (collectively, communication devices 1220) communicatively connected by a PON ODN 1230. The communication system 1200 may be configured to support point-to-multipoint communications (e.g., between one of the communication devices 1210 and some or all of the communication devices 1220, between one of the communication devices 1220 and some or all of the communication devices 1210, or the like, as well as various combinations thereof), may be a configured to support point-to-point communications between one of the communication devices 1210 and one of the communication devices 1220, or the like, as well as various combinations thereof. For example, the communication system 200 may be a PON system (e.g., a 25GS PON system, a 50G PON system, a VHSP PON system, a GPON PON system, an XGS PON system, an NG-PON2 PON system, or the like, as well as various combinations thereof), in which case the communication devices 1210 may be OLTs and the communication devices 1220 may be ONUs. For example, the communication system 1200 may be a point-to-point communication system using transceivers designed for point-to-point communications. It will be appreciated that the PON ODN 1230 may be deployed in various other communication contexts, such that the communication devices 1210 and the communication devices 1220 may include various other types of communication devices which may communicate via a PON ODN architecture.

As depicted in FIG. 12, the PON ODN 1230 may support communications between the communication devices 1210 and the communication devices 1220. The communication devices 1210 and the communication devices 1220 may be said to be associated with different sections of the PON ODN 1230, with the communication device 1210 being said to be associated with a feeder side of the PON ODN 1230 (e.g., in a PON system, this may be based on feeder fibers associated with the OLTs) and the communication devices 1220 being said to be associated with a drop side of the PON ODN 1230 (e.g., in a PON system, this may be based on drop fibers associated with the ONUs). Here, the term feeder side also may be considered to be associated with a side of the PON ODN 1230 having fewer communication devices (e.g., the communication devices 1210 which, in the case of a PON system, may be the OLTs in a central office) and the term drop side also may be considered to be associated with a side of the PON ODN 1230 having more communication device (e.g., the communication devices 1220 which, in the case of a PON system, may be the ONUs at user locations). The communications may include DS communications in the DS direction from the communication devices 1210 toward the communication devices 1220 and US communications in the US direction from the communication devices 1220 toward the communication devices 1210, such that the communication devices 1210 may be defined more generally as devices transmitting in the DS direction and receiving in the US direction and the communication devices 1220 may be defined more generally as devices receiving in the DS direction and transmitting in the US direction.

As depicted in FIG. 12, the PON ODN 1230 may support communications between the communication devices 1210 and the communication devices 1220 based on channel pairs, where a channel pair is a pair of wavelengths or a pair of wavelength bands used for bidirectional communication (e.g., bidirectional in the sense of information flow, not in the sense of fiber cores used) over the PON ODN 1230, by the same optical system (e.g., PON system, point-to-point optical system, or the like), where one of the wavelengths or wavelength bands in the pair is sent in the DS direction and the other of the wavelengths or wavelength bands in the pair is sent in the US direction. Here, the DS direction may be defined more generally as a direction that carries signals on the side of the PON ODN 1230 with fewer endpoints (e.g., communication devices 1210) to the side of the PON ODN 1230 with more endpoints (e.g., communication devices 1220) while the US direction may be defined more generally as a direction that carries signals on the side of the PON ODN 1230 with more endpoints (e.g., communication devices 1220) to the side of the PON ODN 1230 with fewer endpoints (e.g., communication devices 1210). Additionally, here, the channels pairs may be defined more generally such that DS channels are channels of channel pairs propagated in the DS direction from the communication devices 1210 toward the communication devices 1220 and US channels are channels of channel pairs propagating in the US direction from the communication devices 1220 toward the communication devices 1210. For example, in the case where the PON ODN is implemented within a PON system such that the communication devices 1210 are OLTs and the communication devices 1220 are ONUs, the DS direction may be defined as the direction from the central office to the user (with the OLTs on the feeder side of the PON ODN 1230 being the terminals transmitting in the DS direction and receiving in the US direction) and the US direction may be defined as the direction from the users toward the central office (with the ONUs on the drop side of the PON ODN 1230 being the terminals receiving in the DS direction and transmitting in the US direction). Accordingly, it will be appreciated that various PON-specific terms used herein also may be read more generally as covering other types of communication contexts within which the PON ODN 1230 may be deployed.

As depicted in FIG. 12, the PON ODN 1230 includes a passive optical splitter 1231 and an optical core multiplex 1233 including a set of N optical fiber cores 1234, where N≥2. The optical core multiplex 1233 may be implemented on the feeder side of the passive optical splitter 1231 such that the optical fiber cores 134 optical core multiplex 1233 are implemented as optical feeder cores (e.g., as presented with respect to FIGS. 1-6) or may be implemented on the drop side of the passive optical splitter 1231 such that the optical fiber cores 1234 of the optical core multiplex 1233 are implemented as optical drop cores (e.g., as presented with respect to FIGS. 7-11). It will be appreciated that, since either or both of the implementations is possible within the ODN 1230, the optical core multiplex 1233 is only depicted as being generally associated with the ODN 1230. The ODN 1230 may be configured to support one or more PON systems and, for any given PON system having an optical channel pair including a downstream channel and an upstream channel, the optical core multiplex 1233 may be configured such that a first channel of the optical channel pair is absent in at least one of the optical fiber cores 1234 of the optical core multiplex and a second channel of the optical channel pair is propagating in at least one of the optical fiber cores 1234 in which the first channel of the optical channel pair is absent and is used for active communications of the optical system in the at least one of the optical fiber cores 1234 in which the first channel of the optical channel pair is absent. It will be appreciated that a “core duplex” may be understood as a special case of an optical core multiplex with two cores, a “core triplex” may be understood as a special case of an optical core multiplex with three optical cores, and so forth.

As depicted in FIG. 12, the ODN 1230 also may include a multiplex converter element 1239 configured to convert between different numbers of optical fibers. The multiplex converter element 1239 is permit a change of the fiber count from one number of fibers to another number of fibers (e.g., a simplex-duplex converter that converts between one fiber and two fibers, a simplex-triplex converter that converts between one fiber and three fibers, a duplex-triplex converter that converts between two fibers and three fibers, or the like). In the example of FIG. 12, the multiplex converter element 1239 is depicted as being a simplex-duplex converter element that is configured to convert between one fiber core on one side (simplex) and two fiber cores on the other side (duplex). The multiplex converter element 1239 may be configured to operate on wavelength bands, directions, or a combination thereof. The multiplex converter element 1239 may be implemented in one or more locations on the feeder side of the passive optical splitter 1231 and/or on the drop side of the passive optical splitter 1231. It will be appreciated that the directional splitters presented herein are examples of simplex-duplex converters configured to operate on directions.

For example, on the feeder side of the passive optical splitter 1231 where the multiplex converter element 1239 is implemented as a duplex feeder, the multiplex converter element 1239 may be configured as follows depending on whether the passive optical splitter 1231 is a 1×N splitter or a 2×N splitter: (1) when the passive optical splitter 1231 is a 1×N passive splitter on the feeder side, a group of signals (upstream and downstream) will travel through one feeder fiber and the complement of signals will travel in the other feeder fiber (and another simplex-duplex element at the central office may be synchronized with multiplex converter element 1239 at the passive optical splitter 1231 for directing the signals in a correct manner or (2 when the passive optical splitter 1231 is a 2×N passive splitter on the feeder side, the upstream signals will be present in both of the feeder fibers and the downstream signals will be sent in the other feeder fiber (and another simplex-duplex element may be used at the central office to support the direction splitting).

For example, on the drop side of the passive optical splitter 1231 where the multiplex converter element 1239 is implemented as a duplex drop, the multiplex converter element 1239 may be configured as follows depending on whether the passive optical splitter 1231 is a 1×N splitter or a 2×N splitter: (1) when the passive optical splitter 1231 is a 1×N passive splitter on the drop side, a group of signals (upstream and downstream) will travel through one feeder fiber and the complement of signals will travel in the other feeder fiber (and another simplex-duplex element at the user location may be synchronized with multiplex converter element 1239 at the passive optical splitter 1231 for directing the signals in a correct manner or (2) when the passive optical splitter 1231 is a 2×N passive splitter on the feeder side, the downstream signals will be present in both of the feeder fibers and the upstream signals will be sent in the other feeder fiber (and another simplex-duplex element may be used at the user location to support the direction splitting).

It will be appreciated that the multiplex converter element 1239, although primarily presented as being implemented as a simplex-duplex converter element, may be implemented as an M-N converter element where M<N.

It will be appreciated that the communication system 1200 may include various other elements configured to support bidirectional optical communications in an ODN based on use of an optical core multiplex including a set of optical fiber cores in the ODN.

FIG. 13 depicts an example embodiment of a method for supporting bidirectional optical communications in an ODN based on use of an optical core multiplex including a set of optical fiber cores in the ODN. It will be appreciated that, although primarily presented herein as being performed serially, at least a portion of the functions of method 1300 may be performed contemporaneously or in a different order than as presented in FIG. 13. At block 1301, the method 1300 begins. At block 1310, provide a passive optical splitter and an optical core multiplex for use in an optical distribution network of a passive optical network, wherein the optical core multiplex includes a set of optical fiber cores and is configured to support communications of an optical system including an optical channel pair including a downstream channel and an upstream channel. At block 1320, support communications of the optical system such that a first channel of the optical channel pair is absent in at least one of the optical fiber cores of the optical core multiplex and a second channel of the optical channel pair is propagating in at least one of the optical fiber cores in which the first channel of the optical channel pair is absent and is used for active communications of the optical system in the at least one of the optical fiber cores in which the first channel of the optical channel pair is absent. At block 1399, the method 1300 ends.

Various example embodiments of the bidirectional optical communication capability may be configured to provide various advantages or potential advantages. For example, various example embodiments of the bidirectional optical communication capability may be configured to use multiple optical fiber cores in ODN so that detrimental interaction between the downstream optical signals and the upstream optical signals is reduced for even eliminated (e.g., reducing or eliminating the self-induced and coexistence-induced Raman depletion between opposite directions of propagation in the ODN). For example, various example embodiments of the bidirectional optical communication capability may be configured to use multiple optical fiber cores in the ODN, thereby supporting mitigation of self-induced Raman depletion to provide the operator with additional margin on existing PON systems within the PON (e.g., older PON releases) and supporting mitigation of coexistence-induced Raman depletion to ensure that the addition of new PON systems into the PON (e.g., newer PON releases) does not affect the operation of the existing PON systems within the ODN of the PON. For example, various example embodiments of the bidirectional optical communication capability may be configured to use multiple optical fiber cores in the ODN in conjunction with appropriate wavelength assignment between the optical fiber cores (not only limited to direction of propagation separation, as mentioned above, but also to wavelength band separation), cross-impairments among multiple downstream channels or multiple upstream channels also can be reduced or eliminated. It will be appreciated that various example embodiments of the bidirectional optical communication capability may be configured to provide various other advantages or potential advantages.

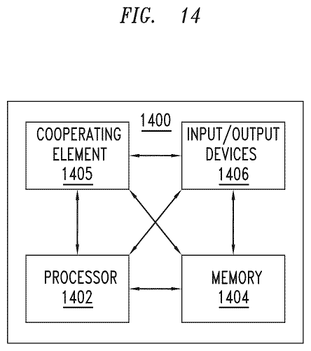

FIG. 14 depicts an example embodiment of a computer suitable for use in performing various functions presented herein.

The computer 1400 includes a processor 1402 (e.g., a central processing unit (CPU), a graphics processing unit (GPU), a network processing unit (NPU), a processor, a processor core of a processor, a subset of processor cores of a processor, a set of processor cores of a processor, or the like) and a memory 1404 (e.g., a random access memory (RAM), a read-only memory (ROM), or the like). In at least some example embodiments, the computer 1400 may include at least one processor (e.g., processor 1402) and at least one memory (e.g., memory 1404) storing instructions that, when executed by the at least one processor, cause the computer 1400 to perform various functions presented herein.

The computer 1400 also may include a cooperating element 1405. The cooperating element 1405 may include a hardware device(s). The cooperating element 1405 may include firmware. The cooperating element 1405 may include a process that can be loaded into the memory 1404 and executed by the processor 1402 to implement various functions presented herein (in which case, for example, the cooperating element 1405 (including associated data structures) can be stored on a non-transitory computer-readable medium, such as a storage device or other suitable type of storage element (e.g., a magnetic drive, an optical drive, or the like)).

The computer 1400 also may include one or more input/output devices 1406. The input/output devices 1406 may include one or more of a user input device (e.g., a keyboard, a keypad, a mouse, a microphone, a camera, a wearable device, or the like), a user output device (e.g., a display, a speaker, a wearable device, or the like), one or more network communication devices or network communication elements (e.g., an input port, an output port, a receiver, a transmitter, a transceiver, an interface, or the like), one or more storage devices (e.g., a tape drive, a floppy drive, a hard disk drive, a compact disk drive, or the like), or the like, as well as various combinations thereof.

It will be appreciated that computer 1400 may represent a general architecture and functionality suitable for implementing functional elements described herein, portions of functional elements described herein, combinations of functional elements described herein, or the like, as well as various combinations thereof. For example, computer 1400 may provide a general architecture and functionality that is suitable for implementing one or more elements presented herein or may provide a general architecture and functionality within which one or more elements presented herein may be utilized. The computer 1400 may provide a general architecture and functionality that is suitable for implementing one or more of a communication device or a portion thereof, an OLT or a portion thereof, an ONU or a portion thereof, or the like.

It will be appreciated that various functions presented herein may be implemented within hardware, a combination of hardware and software, or the like. For example, at least some of the functions presented herein may be implemented in hardware (e.g., using a general purpose computer, one or more application specific integrated circuits, and/or any other hardware equivalents). For example, at least some of the functions presented herein may be implemented in a combination of hardware and software (e.g., via implementation of software on one or more processors, for executing on a general purpose computer (e.g., via execution by one or more processors) so as to provide a special purpose computer, and the like).

It will be appreciated that at least some of the functions presented herein may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored within non-transitory computer-readable media, such as within memory within a computing device operating according to the instructions, within fixed or removable media, or the like. It will be appreciated that the term “non-transitory” as used herein is a limitation of the medium itself (i.e., tangible, not a signal) as opposed to a limitation of data storage persistency (e.g., RAM versus ROM).

It will be appreciated that, as used herein, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other network device or computing device.

It will be appreciated that the term “non-transitory” as used herein is a limitation of the medium itself (i.e., tangible, not a signal) as opposed to a limitation of data storage persistency (e.g., RAM versus ROM).

It will be appreciated that, as used herein, “at least one of <a list of two or more elements>” and “at least one of the following: <a list of two or more elements>” and similar wording, where the list of two or more elements are joined by “and” or “or”, mean at least any one of the elements, or at least any two or more of the elements, or at least all the elements.

It will be appreciated that, as used herein, the term “or” refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

1-20. (canceled)

21. A system, comprising:
a passive optical splitter and an optical core multiplex for use in an optical distribution network of a passive optical network;
wherein the optical core multiplex includes a set of optical fiber cores and is configured to support communications of an optical system including an optical channel pair including a downstream channel and an upstream channel;
wherein a first channel of the optical channel pair is absent in at least one of the optical fiber cores of the optical core multiplex and a second channel of the optical channel pair is propagating in at least one of the optical fiber cores in which the first channel of the optical channel pair is absent and is used for active communications of the optical system in the at least one of the optical fiber cores in which the first channel of the optical channel pair is absent.

22. The system of claim 21, wherein the optical distribution network includes a feeder section between a first set of communication devices and the passive optical splitter and includes a drop section between the passive optical splitter and a second set of communication devices, wherein the optical core multiplex is disposed within the feeder section of the optical distribution network.

23. The system of claim 22, wherein the optical core multiplex includes a first optical feeder core and a second optical feeder core.

24. The system of claim 23, wherein the optical core multiplex is configured to support a condition in which the downstream channel is absent in at least one of the optical feeder cores of the optical core multiplex in which the upstream channel is present, and one of the optical feeder cores of the optical core multiplex where the condition is fulfilled is used for active upstream reception.

25. The system of claim 22, wherein a transmit power of the first set of communication devices is greater than a transmit power of the second set of communication devices.

26. The system of claim 21, wherein the optical distribution network includes a feeder section between a first set of communication devices and the passive optical splitter and includes a drop section between the passive optical splitter and a second set of communication devices, wherein the optical core multiplex is disposed within the drop section of the optical distribution network for a given communication device in the second set of communication devices.

27. The system of claim 26, wherein the optical core multiplex includes a first optical drop core and a second optical drop core.

28. The system of claim 27, wherein the optical core multiplex is configured to support a condition in which the upstream channel is absent in at least one of the optical drop cores of the optical core multiplex in which the downstream channel is present, and one of the optical drop cores of the optical core multiplex where the condition is fulfilled is used for active downstream reception.

29. The system of claim 27, wherein the first optical drop core and the second optical drop core are both directly connected to the passive optical splitter and directly connected to the given communication device.

30. The system of claim 27, wherein the first optical drop core and the second optical drop core are both directly connected to the passive optical splitter, wherein the first optical drop core is connected to a second passive optical splitter disposed between the passive optical splitter and the given communication device, wherein the second optical drop core is directly connected to the given communication device.

31. The system of claim 27, wherein the first optical drop core is directly connected to the passive optical splitter and the given communication device, wherein the second optical drop core is directly connected to a second passive optical splitter and the given communication device.

32. The system of claim 27, wherein the first optical drop core is directly connected to the passive optical splitter and the given communication device, wherein the second optical drop core is directly connected to the optical line terminal and the given communication device.

33. The system of claim 26, wherein a transmit power of the first set of communication devices is less than a transmit power of the second set of communication devices.

34. The system of claim 21, wherein the downstream channel and the upstream channel use a common wavelength.

35. The system of claim 21, wherein the optical distribution network includes a multiplex converter disposed between the optical core multiplex and the passive optical splitter, wherein the multiplex converter is configured to operate on at least one of wavelength bands or direction.

36. The system of claim 21, wherein the optical fiber cores of the optical core multiplex are disposed within at least one optical fiber.

37. The system of claim 21, wherein the optical system includes a point-to-multipoint system or a point-to-point system.

38. The system of claim 21, wherein the optical system includes at least one of a 25GS passive optical network system, a 50G passive optical network system, a VHSP passive optical network system, a GPON passive optical network system, an XGS passive optical network system, or an NG-PON2 passive optical network system.

39. A method for use for a passive optical network, comprising:
providing a passive optical splitter and an optical core multiplex for use in an optical distribution network of a passive optical network, wherein the optical core multiplex includes a set of optical fiber cores and is configured to support communications of an optical system including an optical channel pair including a downstream channel and an upstream channel; and
supporting communications of the optical system such that a first channel of the optical channel pair is absent in at least one of the optical fiber cores of the optical core multiplex and a second channel of the optical channel pair is propagating in at least one of the optical fiber cores in which the first channel of the optical channel pair is absent and is used for active communications of the optical system in the at least one of the optical fiber cores in which the first channel of the optical channel pair is absent.

40. An optical core multiplex for use in an optical distribution network of a passive optical network, comprising:
a set of optical fiber cores configured to support communications of an optical system including an optical channel pair including a downstream channel and an upstream channel;
wherein a first channel of the optical channel pair is absent in at least one of the optical fiber cores of the optical core multiplex and a second channel of the optical channel pair is propagating in at least one of the optical fiber cores in which the first channel of the optical channel pair is absent and is used for active communications of the optical system in the at least one of the optical fiber cores in which the first channel of the optical channel pair is absent.
